(19) United States
(12) Patent Application Publication
(10) Pub. No.: US 2002/0097660 A1
(43) Pub. Date: Jul. 25, 2002

(54) Diffraction grating body, optical pick-up, semiconductor laser apparatus and optical information apparatus

(75) Inventors: Yoshiaki Komma, Hirakata-shi (JP); Seiji Nishino, Osaka-shi (JP); Hidenori Wada, Uji-shi (JP); Teruhiro Shiono, Osaka-shi (JP); Sadao Mizuno, Ibaraki-shi (JP); Hiroshi Shiroiwa, Kyoto-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadomashi-shi (JP)

(21) Appl. No.: 10/010,721

(22) Filed: Nov. 13, 2001

(30) Foreign Application Priority Data
Nov. 16, 2000 (JP) 2000-349344

(51) Int. Cl. G11B 7/135

(52) U.S. Cl. 369/112.04; 369/121; 369/112.07; 369/112.12; 369/120

(57) ABSTRACT

A transmission diffraction grating body including a base material being substantially transparent with respect to wavelength λ1 and having a refractive index n0; another base material being substantially transparent with respect to wavelength λ1 and having a refractive index n1, which is formed on the base material having a refractive index n0; and a relief diffraction grating formed on the base material having a refractive index n1; wherein the refractive indexes n1 and n0 satisfy the relationship: n1>n0. Thus, the base material having a refractive index n1 can be formed of a high refractive index material, and when the depth of grating of the diffraction grating is set so that the diffraction grating diffracts the light with wavelength λ1 and does not diffract the light with wavelength λ2, the depth of grating of the diffraction grating can be made to be shallow, thus preventing the loss of the amount of the light with wavelength λ1. Furthermore, since base materials each having a different refractive index are bonded to each other to form a diffraction grating body, it is possible to minimize the use amount of the relatively expensive material having a high refractive index. Furthermore, since the most of the diffraction grating body can be formed of a material having a low refractive index, it is possible to lower the height of the diffraction index body.

### FIELD OF THE INVENTION

The present invention relates to an optical pick-up and an information recording/reproducing apparatus for recording/reproducing or erasing information with respect to an optical disk, and an information processing system making use thereof, and particularly it relates to a diffraction grating body used therefor.

### DESCRIPTION OF THE PRIOR ART

Optical memory technology that uses optical disks having a pit pattern as high-density, large-capacity information storage media has been expanding its application from digital audio disks to video disks, document file disks, and further to data files.

In recent years, a high-density optical disk such as DVD-ROM etc. using a visible red laser with a wavelength of 630 nm to 670 nm as a light source has become prevalent. Furthermore, an optical disk (DVD-RAM) capable of high density recording has been commercialized. It has been possible to record a large capacity of digital data on an optical disk easily. Furthermore, CD-R that is highly compatible with CD, which has been used broadly, has been prevalent.

From the above-mentioned background, in the information reproducing apparatus with DVD, in addition to DVD-ROM and CD, the reproduction from DVD-RAM and CD-R is important. In the information recording and reproducing apparatus using DVD, in addition to the recording and reproducing function on DVD-RAM, the reproduction with DVD-ROM, CD and CD-R is important. Since the recording/reproducing of information on/from CD-R is carried out by the use of the change in the reflectance of light colors and is optimized to a wavelength around 795 nm, signals may not be reproduced in other wavelengths of light such as visible light.

Therefore, in order to reproduce information from CD-R, it is desirable that an infrared light source having a wavelength about 795 nm is used. The optical pick-up provided with a red semiconductor laser for DVD and an infrared semiconductor laser for CD and CD-R has been developed. For simplifying the optical system so as to achieve miniaturization and low cost, it is proposed that the above-mentioned two kinds of semiconductor lasers, each having a different wavelength, are integrated into one package.

Referring to FIGS. 14 and 15, an optical pick-up disclosed in JP 2000-76689 A will be explained. In the optical pick-up shown in FIG. 14, information recording/reproduction is carried out on/from a plurality of optical disks having transparent substrates with different thicknesses as an optical disk 7 (recording/reproduction herein denotes recording information on an information recording surface of the optical disk 7 or reproducing information from the information recording surface).

As shown in FIG. 14, a conventional optical pick-up apparatus has, as a light source, a first semiconductor laser (red laser) 100a that oscillates in the wavelength of 650 nm and a second semiconductor laser (infrared laser) 100b that oscillates in the wavelength of 780 nm. The first semiconductor laser (red laser) 100a and the second semiconductor laser (infrared laser) 100b are arranged in close contact with each other. This red laser 100a is a light source used for reproducing information from DVD and the infrared laser 100b is a light source used for reproducing information from the second optical disk. These semiconductor lasers are used exclusively depending on the kinds of optical disks with which recording/reproducing is carried out.

Furthermore, a 3-beam diffraction grating 42 that generates three beams for tracking control, a second two-divided hologram 41 that diffracts only the light from an infrared laser and a first four-divided hologram element 40 that diffracts only the light from an infrared laser are arranged on the optical axis of the red laser 100a and the infrared laser 100b. The light emitted from the infrared laser 100a is converged onto the optical disk 7. The reflected light is diffracted by the hologram 41 and led into a photodetector 800.

On the other hand, the light emitted from the infrared laser is split into three beams at the diffraction grating 42 and then converged onto the disk 7. The reflected and returning light is diffracted by the hologram 41 and led into the photodetector 800.

FIG. 15A is an enlarged cross-sectional view showing the vicinity of the 3-beam diffraction grating 42. By setting the depth h1 of the groove of the diffraction grating 42 to be 1.4 μm, it is possible to obtain an appropriate ratio of the light amount of three beams, i.e., a main beam (zero order transmissivity) of 72% and a sub-beam (±first order diffracting efficiency) of 12% with respect to the light with wavelength of 780 nm. It is described that this time, with respect to the light with wavelength of 650 nm, the diffracting efficiency is substantially 0, which is hardly affected.

The configuration the same as the above is disclosed also in JP2000-163791 A. Furthermore, the optical pick-up disclosed in JP10 (1998)-289468 A records/reproduces information on/from a plurality of optical disks such as CD and DVD, etc. The conventional optical pick-up apparatus includes a first semiconductor laser (wavelength λ: 610 nm to 670 nm) as a first light source and a second semiconductor laser (wavelength λ: 740 nm to 830 nm) as a second light source. This first semiconductor laser is a light source used for recording/reproducing information on/from DVD and the second semiconductor laser is a light source used for recording/reproducing information on/from the second optical disk. These semiconductor lasers are used exclusively depending on the kinds of optical disks with which recording/reproducing is carried out.

Furthermore, a synthesizer is provided. The synthesizer synthesizes a light flux emitted from the first semiconductor laser and a light flux emitted from the second semiconductor laser into one identical optical path (which may be substantially the same optical path) to converge the synthesized light fluxes onto the optical disk via a converging optical system. The photodetector and two semiconductor laser chips each having a different wavelength are formed into one unit. The configuration of a 3-beam grating is not disclosed.

Similarly, for the purpose of achieving a small size optical pick-up capable of recording/reproducing information on/from DVD, CD and CD-R, a configuration in which a photodetector and two semiconductor laser chips each having different wavelength are integrated into one unit is disclosed in JP10 (1998)-319318 A, JP 10 (1998)-21577 A, JP 10 (1998)-64107 A, JP 10 (1998)-321961 A, JP10 (1998)-289468A, JP 10 (1998)-134388 A, JP10 (1998)-149559 A, JP10 (1998)-241189 A, etc.

The category of DVD includes DVD-RAM, in addition to DVD-ROM. Therefore, it is desirable that a recording or reproducing apparatus making use of DVD can reproduce information with respect to DVD-ROM, DVD-RAM, CD-ROM, and CD-R (CD-RECORDABLE), the latter two of which have been prevalent. Each of these disks has respective standardizations, and the standardization defines respective tracking error (TE) signal detection methods capable of reproducing information stably.

A TE signal of the DVD-ROM can be obtained by the phase difference detection method. The phase difference detection method also is referred to as a differential phase detection (DPD) method. By using the change in the strength of the far field pattern (FFP) returning from the optical disk by reflection/diffraction, the TE signal can be obtained with one beam. The method uses a change of the diffracted light by the two-dimensional arrangement of pits. The change of the distribution of the light amount in the diffraction by pit rows is detected by the four-divided photodetector to compare the phases, thereby obtaining the TE signal. This method is suitable for a reproduction only disk having pit rows.

A TE signal of the DVD-RAM can be obtained by a push-pull (PP) method. The PP method is used mainly for a write once type optical disk and a rewritable optical disk. When the guide groove of the optical disk recording surface of the optical disk is irradiated with a converged light spot, the reflected light accompanies a diffracted light in the direction in which the guide groove extends and the direction perpendicular to the guide groove. The FFP returning to the surface of the objective lens has an optical intensity distribution due to the interference of the ±first order diffracted light and zero order diffracted light in the guide groove. Depending upon the positional relationship between the guide groove and the converging spot, one part of the FFP becomes bright and another part of the FFP becomes dark, or on the contrary, one part of the FFP becomes dark and another part of the FFP becomes bright. TE signals can be obtained by the PP method by detecting the change in the optical intensity by using the two-divided photodetector.

Also in the CD-ROM (which includes CD for audio) and CD-R, TE signals can be obtained by the PP method from the viewpoint of standards. However, as compared with DVD-RAM, the strength of TE signals thereof is weak. Furthermore, the PP method has a problem in that a TE signal offset occurs due to the lens shift. In DVD-RAM, in order to avoid such a problem, an offset compensation zone for TE signals is provided on a part of the information recording surface. However, there is no means for solving the problem of offset in the case of CD-ROM or CD-R. Therefore, as the TE signal detection method, usually a 3-beam method is used in CD-ROM or CD-R.

In the 3-beam method, the diffraction grating is inserted into the outward path from a light source to an optical disk and a zero order diffracted beam (main beam) and ±first diffracted light beams (sub-beams) of the diffraction grating are formed on the optical disk. When the main beam is deviated from the center of the track, one of the sub-beams approaches to the center of the track and the other sub-beam is distant from the center of the track, thus causing a difference in the amount of reflected return light. By detecting this difference, TE signals can be obtained.

As mentioned above, for recording or reproducing information on or from DVD-ROM, DVD-RAM, and CD-ROM, CD-R, it is desirable to carry out three kinds of methods, i.e., the phase difference method, PP method, 3-beam method.

In the above-mentioned conventional method (JP 2000-76689 A), in order to realize the 3-beam method at the time of reproducing information from CD, the diffraction grating for generating three beams is inserted into an optical path and the depth of the groove of the diffraction grating 30 for three beams is set to be 1.4 μm so that the loss of light does not occur at the time of reproducing information from DVD.

However, in this configuration, for making the diffracting efficiency to be substantially 0 with respect to the light with wavelength of 650 nm, it is required, as a precondition, that the cross-sectional shape of the diffraction grating has an ideal rectangular shape. If the depth of the groove is as large as 1.4 μm, it is difficult to realize the ideal rectangular-shaped cross section. As a result, as shown in FIG. 15B, the sidewall is inclined. In the example of FIG. 15B, between the concave portion and the convex portion, the phase difference due to the difference hi of optical path becomes 27π, and the phase of a red light 70 is substantially the same as that of a red light 71. Consequently, the diffraction does not occur. However, if the sidewall is inclined, when the height is, for example, h2, the red light 72 enters. In this case, in the red light 71 and the red light 72, the phase difference becomes, for example, π, and thus diffraction occurs.

Furthermore, even if the cross-section of the diffraction grating can be formed in an ideal rectangular shape, the factor of scattering light at the sidewall is increased. Consequently, the resultant transmitting efficiency becomes lower than the transmitting efficiency calculated based on the scalar calculation. When the depth of the groove is large like this, instead of the scalar calculation of approximation, a more precise vector calculation must be carried out. For example, when it is assumed that the ideal rectangular cross-sectional shape can be formed when the periodic cycle of the grating is 6 μm, the refractive index of the base material is 1.5, the wavelength is 650 nm and the depth of the groove is 1.3 μm, the transmissivity becomes 100% from the scalar calculation, but the transmissivity becomes only about 80% from the vector calculation.

Therefore, in the conventional configuration, there is a problem in that at the time of reproduction of information from DVD, an optical loss of red light occurs, and the signal/noise (S/N) ratio of the reproduced signal becomes low, thus increasing the necessary amount of red light to be emitted and increasing the consumption of electric power.

### SUMMARY OF THE INVENTION

It is an object of the present invention to solve the above-mentioned problems and to provide a diffraction grating body for generating three beams, which is capable of reducing the amount of loss of light with wavelength that is not diffracted, and an optical pick-up, a semiconductor laser apparatus and an optical information apparatus using the same.

In order to achieve the above-mentioned object, a first diffraction grating body of the present invention includes a base material being substantially transparent with respect to wavelength λ1 and having a refractive index n0; another base material being substantially transparent with respect to wavelength λ1 and having a refractive index n1, which is formed on the base material having a refractive index n0; and a relief diffraction grating formed on the base material having a refractive index n1; wherein the refractive indexes n1 and n0 satisfy the relationship: n1>n0.

According to the above-mentioned diffraction grating body, since the base material having a refractive index n1 can be formed of a high refractive index material, and when the depth of grating of the diffraction grating is set so that the diffraction grating diffracts the light with wavelength λ1 and does not diffract the light with wavelength λ2, the depth of grating of the diffraction grating can be made to be shallow, thus preventing loss in the amount of the light with wavelength λ1. Furthermore, since base materials each having a different refractive index are bonded to each other to form a diffraction grating body, it is possible to minimize the amount used of relatively expensive material having a high refractive index. Furthermore, since most of the diffraction grating body can be formed of a material having a low refractive index, it is possible to reduce the height of the diffraction index body.

In the diffraction grating body, it is preferable that the diffraction grating is formed of a concave portion and a convex portion having rectangular-shaped cross sections and the level difference h between the concave portion and the convex portion satisfies the following relationship:

h=λ1/(n1−1)

and the difference in an optical path between the concave portion and the convex portion is set to correspond to one wavelength with respect to wavelength λ1.

With such a diffraction grating body, since the difference in an optical path between the concave portion and the convex portion corresponds to one wavelength, it is possible to obtain a configuration in which the light with wavelength λ1 is not diffracted and the light with wavelength λ2 is diffracted.

Furthermore, it is preferable that the refractive index n1 is 1.9 or more. With such a diffraction grating body, since the refractive index is large, the depth of grating of the diffraction grating can be made to be shallow. Therefore, in the case where the light with wavelength λ1 is set to be not diffracted, the loss in the amount of the light with wavelength λ1 can be reduced. Furthermore, the shape of the convexity and the concavity of the diffraction grating can be made to be an ideal rectangular shape easily, enabling the light with wavelength λ1 not to be diffracted securely.

Furthermore, it is preferable that a material of the base material having the refractive index n1 is at least one material selected from the group consisting of Ta₂O₅, TiO₂, ZrO₂, Nb₂O₃, ZnS, LiNbO₃ and LiTaO₃. With the use of the above-mentioned materials, it is possible to obtain a high refractive index n1 as high as 1.9 or more.

Furthermore, it is preferable that the diffraction grating is formed of a concave portion and a convex portion having rectangular-shaped cross sections, and the film thickness of the base material having the refractive index n1 is the same as the level difference h between the concave portion and the convex portion. With such a diffractive grating body, a diffraction grating body can be produced by the lift-off technique.

Furthermore, the diffraction grating body according to claim 1, further comprising an anti-reflection film in the interface between the base material having a refractive index n1 and the air, and the interface between the base material having the refractive index n1 and the base material having a refractive index n0. With such a diffraction grating, the transmissivity can be improved securely.

Next, a second diffraction grating body of the present invention includes a base material, and a relief diffraction grating formed on the base material, wherein the diffraction grating body is formed of a single base material, and the refractive index n1 of the single base material is 1.9 or more.

According to the above-mentioned diffraction grating body, when the depth of grating of the diffraction grating is set so that the diffraction grating diffracts the light with wavelength λ1 and does not diffract the light with wavelength λ2, the depth of grating of the diffraction grating can be made to be shallow, thus reducing the loss in the amount of the light with wavelength λ1. Furthermore, since the diffraction grating is formed of a single base material, it is not necessary to bond the base materials each other, thus making the production easy. Furthermore, it becomes easy to make the convex portion and the concave portion of the diffraction grating to be an ideal rectangular shape, enabling the light with wavelength λ1 not to be diffracted securely.

In the above-mentioned second diffraction grating, it is preferable that the diffraction grating is formed of a concave portion and a convex portion having rectangular-shaped cross sections, and the level difference h between the concave portion and the convex portion satisfies the following relationship:

h=λ1/(n1−1)

and the difference in an optical path between the concave portion and the convex portion is set to correspond to one wavelength with respect to the wavelength λ1. With such a diffraction grating body, since the difference in an optical path between the concave portion and the convex portion corresponds to one wavelength with respect to wavelength λ1, it is possible to obtain a configuration in which the light with wavelength λ1 is not diffracted and the light with wavelength λ2 is diffracted.

Furthermore, it is preferable that a material of the single base material is at least one material selected from the group consisting of Ta₂O₅, TiO₂, ZrO₂, Nb₂O₃, ZnS, LiNbO₃ and LiTaO₃. With the use of the above-mentioned materials, it is possible to obtain a high refractive index n1 as high as 1.9 or more.

Next, the semiconductor laser apparatus of the present invention is provided with the above-mentioned diffraction grating body and includes: a semiconductor laser for emitting a light beam with wavelength λ1 and a light beam with wavelength λ2; and a photodetector for receiving the light beams emitted from the semiconductor laser and carrying out photoelectric conversion; wherein the diffraction grating body receives the light beam with wavelength λ2 and transmits a main beam and generates sub-beams that are ±first order diffracted light; and the diffraction grating body, the semiconductor laser and the photodetector are integrated into one package.

According to the above-mentioned semiconductor laser apparatus, since the diffraction grating body according to the present invention is used, it is possible to reproduce information from an optical disk (for example, CD-R) corresponding to the wavelength λ2 stably and enhance the efficiency of using light when information is reproduced from an optical disk (for example, DVD-ROM) corresponding to the wavelength λ1. Furthermore, since the diffraction grating body, the semiconductor laser and the photodetector are integrated into one package, it is possible to detect a stable servo signal that is not susceptible to the effect of distortion due to the change in temperatures.

Furthermore, the optical pick-up according to the present invention is provided with each of the above-mentioned diffraction grating bodies and includes a first semiconductor laser light source for emitting a light beam with wavelength λ1; a second semiconductor laser light source for emitting a light beam with wavelength λ1; an optical system for receiving the light beam with wavelength λ1 and the light beam with wavelength λ2 and converging the light beam onto a microspot on the optical disk; a diffraction means for diffracting a light beam reflected from the optical disk; and a photodetector having a photo detecting portion for receiving the diffracted light diffracted by the diffraction means to output electrical signals in accordance with the amount of the diffracted light; wherein the diffraction grating body receives the light beam with wavelength λ2 and transmits a main beam and generates sub-beams that are ±first order diffracted light.

According to the above-mentioned optical pick-up, since the diffraction grating body according to the present invention is used, it is possible to reproduce information from an optical disk (for example, CD-R) corresponding to the wavelength λ2 stably and enhance the efficiency of using light when information is reproduced from an optical disk (for example, DVD-ROM) corresponding to the wavelength λ1. Therefore, it is possible to obtain the effect that the S/N ratio is high and reproduction is carried out stably with the power consumption lowered.

In the above-mentioned optical pick-up, it is preferable that the photo detecting portion comprises a photo detecting portion PD0 for receiving a +first order diffracted light from the diffraction means, and a distance d1 between the center of the photo detecting portion PD0 and the light emitting spot of the first semiconductor laser light source and a distance d2 between the center of the photo detecting portion PD0 and the light emitting spot of the second semiconductor laser light source substantially satisfy the following relationship: λ1/λ2=d1/d2.

With such an optical pick-up, the photo detecting portion can be used commonly for both wavelengths, and thus it is possible to reduce the number of the photo detecting portions and to reduce the area of the photodetector and the number of the circuit elements for converting output signals into current/voltage signals, thus realizing the cost reduction and miniaturization of the apparatus.

Furthermore, it is preferable that the diffraction grating body, the semiconductor laser and the photodetector are integrated into one package. With such an optical pick-up, since components necessary to produce a servo signal can be fixed adjacent to each other, it is possible to detect a stable servo signal that is not susceptible to the effect of distortion due to the change in temperatures.

Next, the optical information apparatus of the present invention is provided with the above-mentioned optical pick-up and includes a focus control means with respect to an optical disk; a tracking control means; and an information signal detecting means; and further includes a moving means for moving the optical pick-up; and a rotation means for rotating the optical disk. According to the above-mentioned optical information apparatus, since the optical pick-up according to the present invention is used, it is possible to obtain the effect that the S/N ratio is high and the reproduction can be carried out stably with the power consumption lowered.

### BRIEF DESCRIPTION OF THE DRAWINGS

FIG. 1 is a schematic cross-sectional view showing an optical pickup according to one embodiment of the present invention.

FIG. 2 is a schematic cross-sectional view showing an operation of the optical pick-up of FIG. 1.

FIG. 3 is a schematic cross-sectional view showing another operation of the optical pick-up of FIG. 1.

FIG. 4 is a cross-sectional view showing a diffraction grating used for the optical pick-up of FIG. 1.

FIG. 5 is a schematic cross-sectional view showing an operation of an optical pick-up according to one embodiment of the present invention.

FIG. 6 is a schematic cross-sectional view showing an operation of an optical pick-up according to another embodiment of the present invention.

FIG. 7 is a schematic perspective view showing a photodetector according to one embodiment of the present invention.

FIG. 8 is a schematic plan view showing a configuration and an operation of a photodetector according to one embodiment of the present invention.

FIG. 9 is a view to illustrate an operation of a photodetector according to one embodiment of the present invention.

FIG. 10 is a schematic plan view showing an operation of a photodetector according to one embodiment of the present invention.

FIG. 11 is a cross-sectional view showing a diffraction grating body according to one embodiment of the present invention.

FIG. 12 is a cross-sectional view showing a diffraction grating body according to another embodiment of the present invention.

FIG. 13 is a schematic view showing a configuration of an optical information apparatus according to another embodiment of the present invention.

FIG. 14 is a schematic cross-sectional view showing an example of a conventional optical pick-up.

FIG. 15A is a cross-sectional view showing an example of a conventional optical pick-up.

FIG. 15B is an enlarged view showing a main part of the diffraction grating body shown in FIG. 15A.

### DESCRIPTION OF THE PREFERRED EMBODIMENTS

Hereinafter, the present invention will be described by way of embodiments with reference to the accompanying drawings.

Embodiment 1

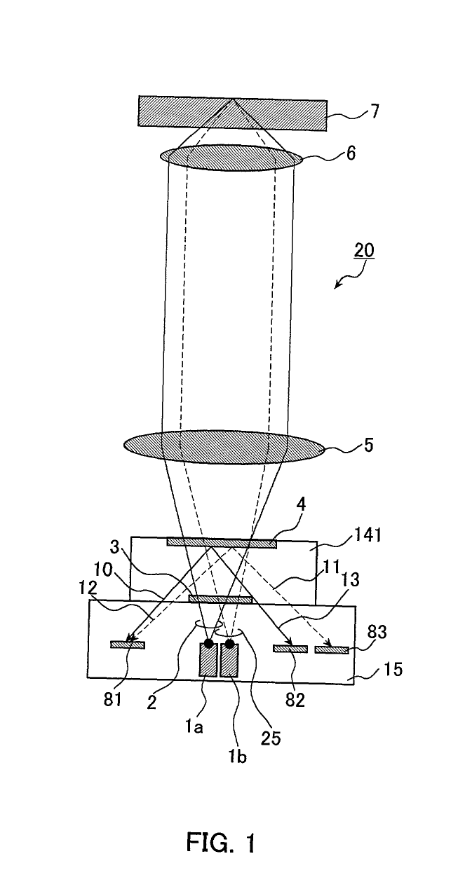

FIG. 1 shows a configuration of an optical pick-up according to one embodiment of the present invention. In FIG. 1, reference numerals 1b and 1a are laser light sources, each having a different wavelength. Reference numerals 81, 82 and 83 denote photodetectors for receiving light beams and photoelectrically converting the received light beams into electric signals such as electric current, etc. Reference numeral 3 denotes a diffraction grating.

Reference numeral 4 denotes a diffraction means. As the diffraction means 4, an optical element whose phase or transmissivity has a periodic structure is used. In the diffraction means 4, the period or direction, that is, a grating vector, may vary depending on location. A representative example of the diffraction means 4 is a hologram, for example, a phase-type hologram. In the explanation below, the hologram will be explained as an example of the diffraction means 4. Reference numeral 5 denotes a collimating lens and 6 denotes an objective lens which constitute a light converging system. Reference numeral 7 denotes an optical disk.

Moreover, in the optical pick-up shown in this figure, a portion including the semiconductor laser light source and the photo detecting portion corresponds to a semiconductor laser apparatus. The same is true in the below mentioned embodiments.

An example of the optical disk 7 includes both CD, CD-R or the like having a base material thickness (a thickness between a surface where light beams output from the objective lens enter and an information recording surface) t1 of about 1.2 mm and DVD (DVD-ROM, DVD-RAM, or the like) having a base material thickness t2 of about 0.6 mm. Hereinafter, an optical disk having a base material thickness of about 1.2 mm and having the same recording density as that of CD-ROM will be referred to as a CD optical disk, and an optical disk having a base material thickness of about 0.6 mm and having the same recording density as that of DVD-ROM will be referred to as a DVD optical disk.

As one example, the laser light sources 1a and 1b can be arranged in a form of a hybrid as separate semiconductor laser chips. In this case, since each semiconductor laser chip can be made to be a minimum size and can be produced by respective optimum methods, it is possible to realize low noise, low consumption of electric current, and high durability. As another example, the laser light sources 1a and 1b may be formed into one semiconductor laser chip monolithically. In this case, it is possible to reduce the manhours for assembling steps or to determine a distance between two light emitting points exactly. These configurations can be applied for the following optical pickups and all the embodiments.

The photo detecting portions 81, 82, and 83 also are referred to as PD0, PD1, and PD2 respectively. The photo detecting portions 81, 82, and 83 are separated in FIG. 1. However, by forming them on a single silicon substrate, the relative positional relationship of them can be determined precisely.

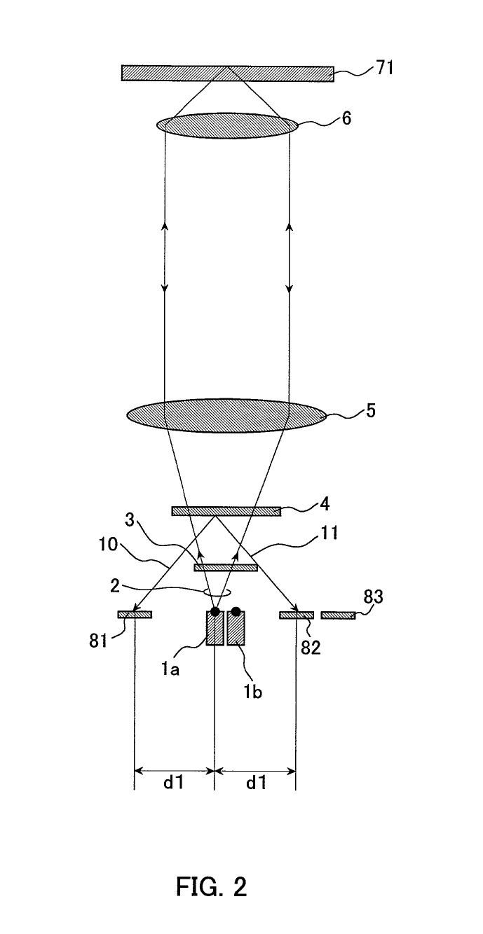

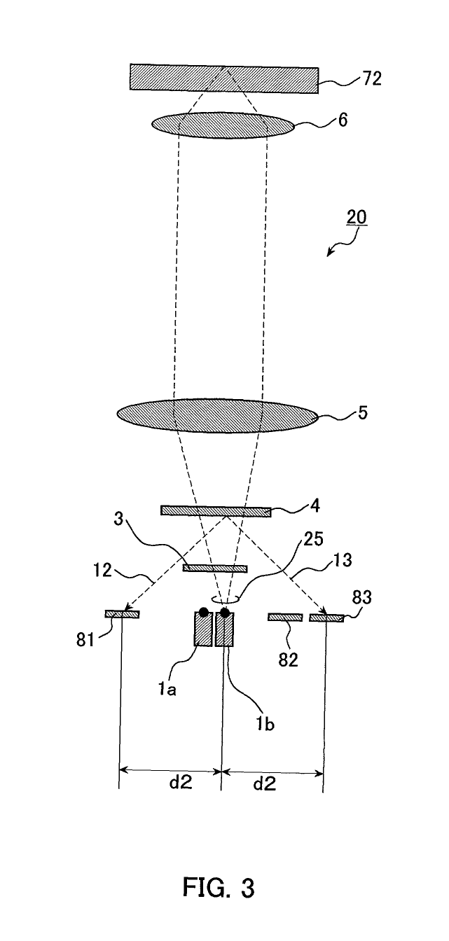

An operation of recording or reproducing information on or from to the optical disk will be explained with reference to FIGS. 2 and 3. FIG. 2 is a view to explain an operation of recording or reproducing information on or from a DVD (DVD-ROM, DVD-RAM, etc) optical disk 71 having a base material thickness t2 of about 0.6 mm by using the red laser light source.

The red light beam 2 emitted from a red semiconductor laser la passes through a diffraction grating 3 and a hologram 4, and is collimated by a collimating lens 5 into a nearly parallel light beam, and converged onto an optical disk 71 by an objective lens 6. Furthermore, the red light beam diffracted and reflected by pits or track grooves formed on the information recording surface of the optical disk 71 returns on substantially the same optical path by way of the objective lens 6 and the collimating lens 5, and again enters the hologram 4 to generate a +first-order diffracted light 10 and a −first-order diffracted light 11. The +first-order diffracted light 10 and the −first-order diffracted light 11 enter the photo detecting portion 81 and the photo detecting portion 82 respectively, and are photoelectrically converted.

Herein, when the distance between the center of the photo detecting portion 81 and the light emitting spot of the red laser 1a is set to be d1, it is necessary that the distance between the center of the photo detecting portion 82 receiving −first-order diffracted light 11 that is conjugated with respect to the +first-order diffracted light 10 also should be set to be substantially d1.

FIG. 3 is a view to explain an operation of recording or reproducing information on or from a CD (CD-ROM, CD-R, etc.) optical disk 72 having a base material thickness t1 of about 1.2 mm by using the infrared laser light source 1b.

The infrared light beams 25 emitted from the infrared semiconductor laser 1b are diffracted in passing through the diffraction grating 3 to generate ±first-order sub-spots, pass through the hologram 4 together with a zero-order diffracted light (main spot), and are converged onto an optical disk 72 by a collimating lens 5 and an objective lens 6. Furthermore, the light beams diffracted and reflected by pits or track grooves formed on the information recording surface of the optical disk 72 return on substantially the same optical path by way of the objective lens 6 and the collimating lens 5, and again enter the hologram 4 to generate a +first-order diffracted light 12 and a −first-order diffracted light 13. The +first-order diffracted light 12 and −first-order diffracted light 13 enter the photo detecting portion 81 and the photo detecting portion 83 respectively, and are converted photoelectrically.

Herein, when the distance between the center of the photo detecting portion 81 and the light emitting spot of the red laser 1b is set to be d2, the distance between the center of the photo detecting portion 83 receiving first-order diffracted light 13 that is conjugated with respect to the +first-order diffracted light 12 also is substantially d2.

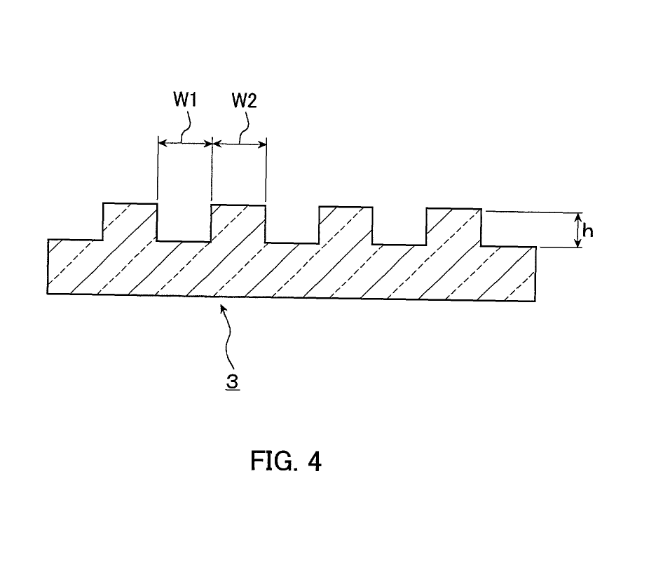

FIG. 4 is a cross-sectional view showing the diffraction gating 3. This figure is shown by turning FIG. 1 upside down for convenience. The diffraction grating shown in FIG. 4 is a relief diffraction grating in which the diffraction grating is formed by the convexity and concavity of a member material. The cross-sectional shape of the concave and convex portions of the diffraction grating 3 is substantially a rectangular shape, and the width W1 of the concave portion and the width W2 of the convex portion are substantially the same.

In this embodiment, the level difference h between the concave portion and the convex portion of the cross sectional shape, that is, the depth of grating (height of the convex portion from the bottom surface of the concave portion), is set to satisfy the following equation (1):

h=λ1/(n1−1) (1)

wherein λ1 denotes a wavelength of the red light beam 2, and n1 denotes a refractive index of a material of the diffraction grating with respect to the wavelength λ1.

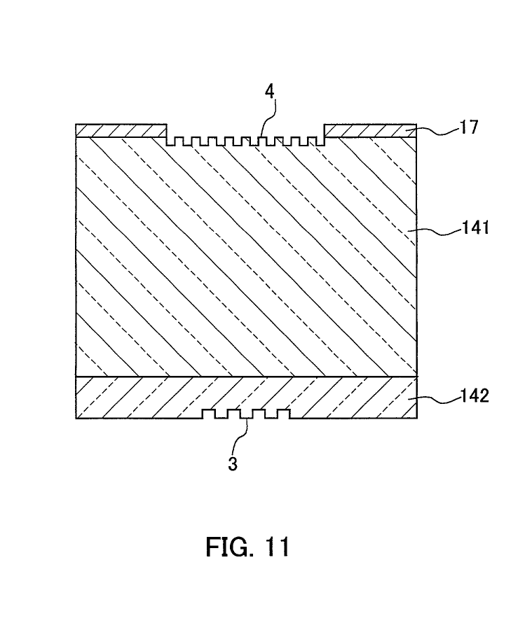

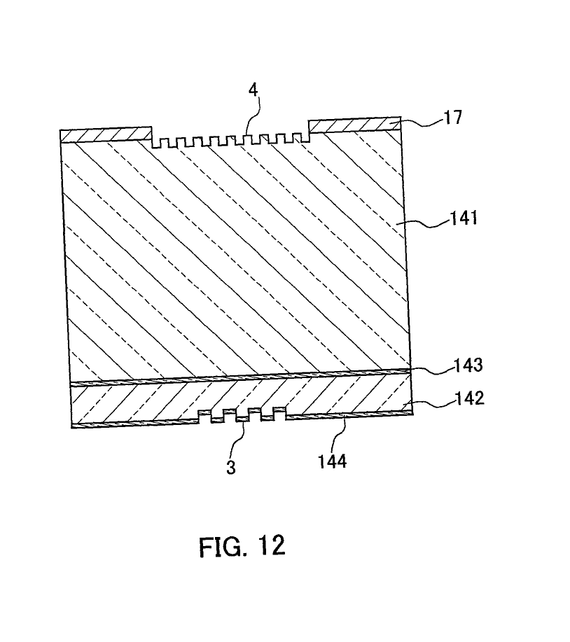

When the level difference h satisfies the above-mentioned equation (1), the difference in an optical path between the concave portion and the convex portion corresponds to one wavelength with respect to the red light beam. Thus, a phase difference due to the difference of the optical path becomes 2π, and the phases of the red light become substantially the same in the convex portion and concave portion. Therefore, in design based on the scalar calculation, the red light is not diffracted by the diffraction grating 3. Furthermore, since the wavelength of the infrared light is longer than that of the red light, the difference in the optical path generated due to the level difference h is smaller than one wavelength and also the phase difference is smaller than 2π. Consequently, diffraction necessarily occurs, thus enabling sub-spots to be generated as mentioned above. A more detailed configuration of the diffraction grating will be explained later with reference to FIGS. 11 and 12.

Moreover, in the case of reproducing information from a CD optical disk by using an infrared light beam, the NA is desirably 0.4 or more. However, it is necessary to form grating stripes in the sufficiently broad range of the diffraction grating 3 so that the diffracted light beams are generated from the entire range in which the NA of the sub-beam becomes 0.4 or more at the objective lens 6. Furthermore, it is desirable in design that the red light beam is not diffracted. However, it is thought that the diffraction somewhat occurs due to the manufacturing error, etc. When a part of the red light beam transmits through a portion of the diffraction grating 3 not including grating stripes and enters the objective lens 5, the intensity and phase inconsistency (difference depending upon places) occurs between the red light beam passing through the portion without including grating stripes of the diffraction grating 3 and the red light beam passing through the grating stripes, which may lead to the deterioration in the performance of converging light beams onto the recording surface of the optical disk 71.

Therefore, it is desirable that the grating stripes are formed on the entire range in which the light beam entering the objective lens 5 without being diffracted by the diffraction grating 3 satisfies the NA (0.6) that is necessary to the information reproduction from a DVD optical disk.

However, when the diffracted light 12 or diffracted light 13, which is reflected by and returned from a CD optical disk 72, enters the hologram 4 and is diffracted, enters the diffracted stripes, the light is diffracted further, thus causing the loss of the amount of light. In order to avoid this, it is necessary to limit the range of the grating stripes on the diffraction grating 3 for the diffracted light 12 or diffracted light 13. For example, by forming grating stripes in the portion shown by the grating 3 in shade in FIG. 1, the converging spot performance can be secured when reproducing information from a DVD optical disk. Moreover, the loss of the light amount can be prevented when reproducing information from a CD optical disk.

The diffraction grating 3 includes grating stripes, and has a transparent substrate (not shown in figure) in the broader range, and the diffracted light 12 or diffracted light 13 passes through the transparent portion (on which the grating stripes are not formed).

Furthermore, a DVD optical disk is a higher density optical disk compared with a CD optical disk. The DVD disk is required to reproduce (or record) information with a converging spot having less aberration than that of the CD optical disk. Therefore, it is desirable that the light emitting spot of the red semiconductor laser 1a is arranged on the optical axis (in this embodiment, an optical axis of the collimating lens 5) of the light converging system within the range of the assembly tolerance. Thereby, the laser light from short wavelength laser apparatus, which is easily affected by lens aberration, passes in the vicinity of the optical axis of the collimating lens 5 having a small lens aberration. Therefore, off-axis aberration does not occur when information is reproduced from the DVD optical disk. Thus, it is possible to reproduce (or to record) information with respect to the DVD optical disk stably and with higher density.

Furthermore, the relationship between the distance d1 from the center of the photo detecting portion 81 to the light emitting spot of the red laser 1a and the distance d2 from the center of the photo detecting portion 81 to the light emitting spot of the infrared laser 1b and the wavelength is explained. Since the diffraction distance is substantially proportional to the wavelength, the arrangement is carried out so that the equations (2) and (2)′ are satisfied:

d1:d2=λ1: λ2 (2),

that is,

d1/d2=λ1/λ2 (2)′

wherein λ1 denotes a wavelength of the red laser and λ2 denotes a wavelength of the infrared laser. Thus, since the photo detecting portion 81 can be used commonly for both wavelengths, and the number of the photo detecting portions can be reduced, it is possible to reduce the area of the photodetector and the number of the circuit elements converting output signals into current/voltage signals, thus enabling the cost reduction and the miniaturization of the apparatus to be realized. Furthermore, as is apparent from FIGS. 2 and 3, when the distance between the light emitting spot of the red laser 1a and the light emitting spot of the infrared laser 1b is d12, the following equation is satisfied:

d2=d1+d12 (3)

and from the equations (2) and (3), the following equations (4) and (5) are satisfied:

d1=λ1·d12/(λ2−λ1) (4)

d2=λ2·d12/(λ2−λ1) (5)

Thus, since the photo detecting portion 81 can be used commonly for both wavelengths, and the number of the photo detecting portions can be reduced, it is possible to reduce the area of the photodetector and the number of the circuit elements for converting output signals into current/voltage signals, thus realizing the cost reduction and miniaturization of the apparatus.

In the above-mentioned equations (2′), (4) and (5), both sides of the equation are substantially the same. In other words, this includes not only the case where values of both sides are completely equal, but also the case where the values of the both sides are substantially equal to such an extent that the intended effects to be obtained by the equations are achieved without practical problems.

(Second Embodiment)

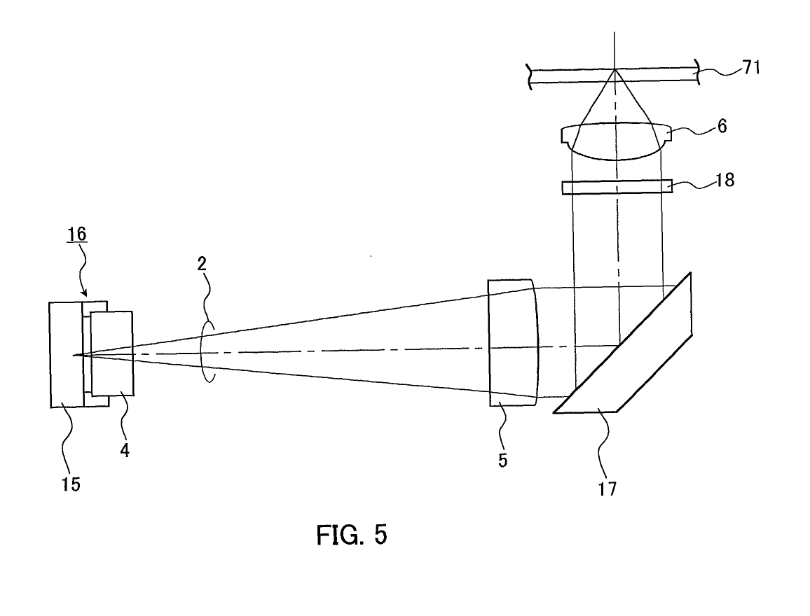

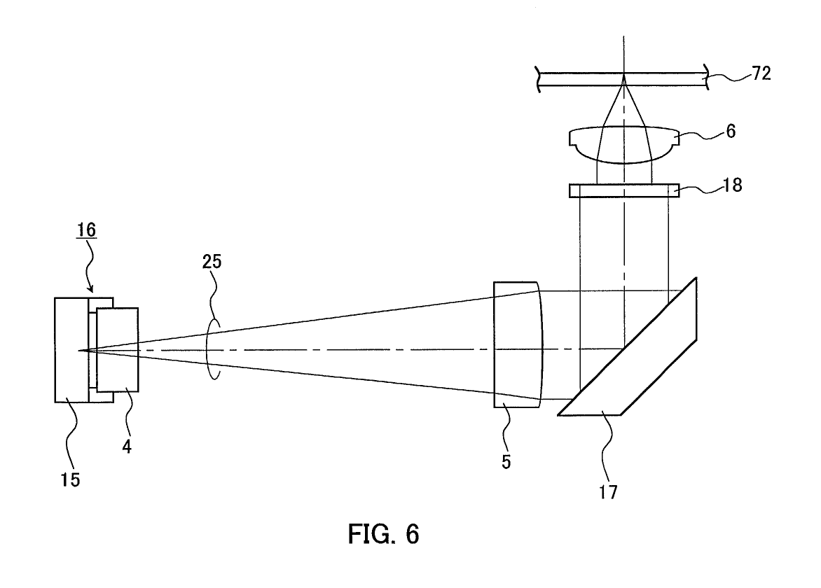

FIGS. 5 and 6 show an embodiment in which a thin optical pick-up is configured by using a rising mirror. FIG. 5 shows a case where information is reproduced from a DVD optical disk by emitting a red light beam 2. The light collimated by the collimating lens 5 into nearly parallel light beams is reflected by the rising mirror 17 and changes the direction of travel, thereby reducing the size (thickness) of the optical pick-up in the direction perpendicular to the plane of the optical disk 71. Awavelength selection aperture 18 just behaves as a transparent substrate with respect to the red light beam 2 and does not act on it.

As shown in FIG. 6, the wavelength selection aperture 18 shields light beams distant from the optical axis with respect to the infrared light. This wavelength selection aperture can be obtained by forming dielectric multi-layered films having different wavelength properties in the vicinity of the optical axis and on the outer peripheral portion distant from the optical axis, or by forming a phase grating having different phase modulation amounts.

Since the DVD optical disk has higher recording density, information reproduction requires a larger NA as compared with a CD optical disk. Therefore, by using the means for changing the NA in accordance with wavelength, NA is set to be a necessary minimum when reproducing information from a CD optical disk while reducing the aberration due to the thickness of the base material or the inclination of the disk. However, the present invention is not necessarily limited to a configuration equipped with a wavelength selection aperture.

In FIGS. 5 and 6, reference numeral 15 denotes a package. The package 15 includes at least a red laser 1a and an infrared laser 1b and photodetector in which photo detecting portions 81 to 83 are formed. One component in which a light source and photodetector are integrated into one piece will be referred to as a unit in the following. The hologram 4 may be formed near the collimating lens 5. However, by integrating also the hologram 4 into the unit 16, it is possible to fix the components necessary to produce servo signals closely to each other. Therefore, it is possible to detect servo control signals stably, which are not susceptible to a distortion due to changes in temperature.

(Third Embodiment)

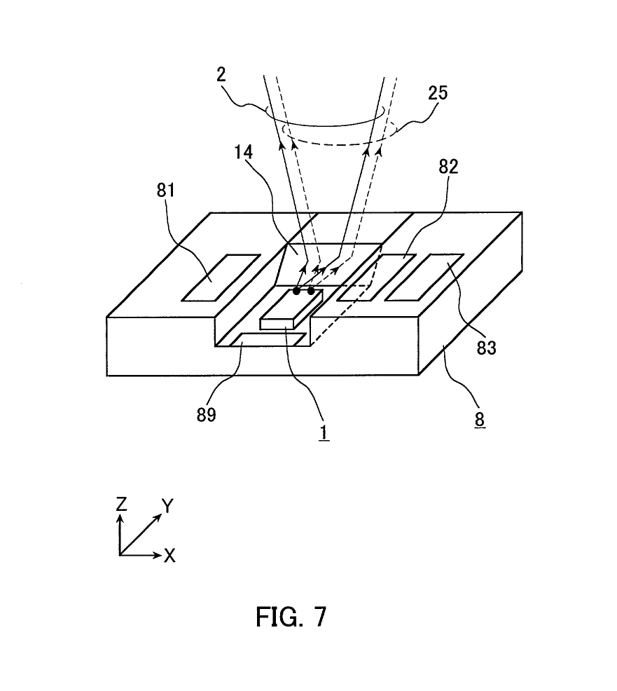

Next, an embodiment in which the red laser 1b and the infrared laser 1a, and a photodetector provided with photo detecting portions 81 to 83 are integrated will be explained with reference to FIG. 7. Reference numeral 8 denotes a photodetector, in which the photo detecting portions 81 to 83 are formed on a silicone substrate, etc. By integrating all of the photo detecting portions on one substrate like this, it is possible to reduce the manhours for electrical connection and to determine the relative positions between the photodetectors with high precision.

Reference numeral 1 denotes a semiconductor laser light source in which a red laser 1b and an infrared laser 1a are integrated monolithically. By integrating lasers having two different wavelengths on one chip of the semiconductor laser light source like this, the distance between the light emitting spot of the red laser 1b and the light emitting spot of the infrared laser 1a can be set precisely in a μm order or a sub μm order. Therefore, the detection signals using lights of both wavelengths are allowed to have excellent properties.

A small reflecting mirror 14 is provided in the direction in which the red light beam 2 or the infrared light beam 25 is emitted from the laser 1. The mirror 14 allows the optical axis of the red light beam 2 or the infrared light beam 25 to be bent into the direction perpendicular to the surface made by the photo detecting portions 81 to 83.

This mirror 14 can be formed by anisotropic etching of the silicon of the substrate, or adhering the small size prism mirror to the photodetector 8. By providing a photo detecting portion 89 also on the side opposite to the mirror 14 with respect to the laser 1, the amount of light emitted from the laser 1 in the direction thereof, and the light amount can be utilized for the signal for controlling the amount of light.

(Fourth Embodiment)

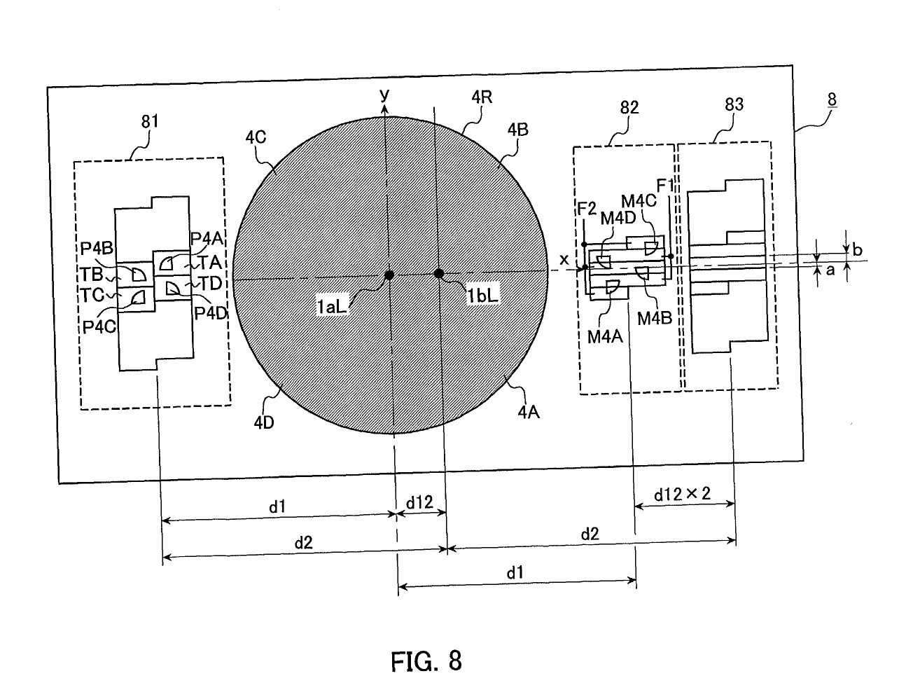

Next, detailed configurations of the photo detecting portions 81 to 83 and the hologram 4 will be explained with reference to FIGS. 8, 9, and 10.

FIG. 8 is a view of the photodetector 8 seen from the direction perpendicular to the surface thereof. An effective diameter of the red light beam on the hologram 4 when the red laser 1a is emitted, that is, when reproduction with respect to a DVD optical disk is carried out (that is, a projection of the effective diameter of the objective lens 5) and the state of the diffracted light generated from the hologram 4 on the photodetector are shown. 1aL denotes a light emitting spot of the red semiconductor laser 1a, and the effective diameter of the light beam on the hologram 4 expands with the light emitting spot 1aL as a center. The photo detecting portions 81, 82, and 83 may be formed individually on a Si substrate, etc. and assembled in a hybrid form, or some parts of them may be formed on the common substrate, or all of them, as shown in FIG. 8, may be formed on the common substrate. Thereby, it is possible to determine the positional relationship to each other with high accuracy and easily. Furthermore, by forming also the semiconductor laser 1 on the same substrate, the relative positional relationship between them with respect to the photo detecting portion becomes stable, thus enabling servo control signals to be obtained stably.

P4A, P4B, P4C and P4D are +first order diffracted light diffracted by the hologram 4. M4A, M4B, M4C and M4D are −first order diffracted light diffracted by the hologram 4. The hologram 4 is divided into at least four parts by an x-axis and a y-axis. The hologram is designed so that P4A and M4A are diffracted by the region 4A, P4B and M4B are diffracted by the region 4B, P4C and M4C are diffracted by the region 4C, and P4D and M4D are diffracted by the region 4D. In FIG. 8, only a part of the hologram 4 is shown as an infrared light 4R on the hologram. The hologram 4 is formed in a range broader than 4R.

A focus error signal can be obtained by receiving −first order diffracted light M4A, M4B, M4C, and M4D, which are diffracted by the hologram 4 in the photo detecting portion 82. For example, a wavefront is designed so that M4A and M4D are focused on the side opposite to the collimating lens 5 (see FIG. 1) with respect to the surface of the photo detecting portions 82 (this will be referred to as a rear pin); and M4B and M4C are focused on the same side as the collimating lens 5 (see FIG. 1) with respect to the surface of the photo detecting portion 82 (this will be referred to as a front pin). In other words, the wavefronts each are designed to have a different focus position are designed in the direction of an optical axis.

When a gap between the DVD optical disk 71 and the objective lens shifts in the direction of the optical axis, that is, due to the defocus, in the front and the rear sides of the position where the converging spot is focused on the information recording surface, the magnitude of the diffracted light on the photo detecting portion 82 is changed. This change is a movement that becomes contrary to the difference in the focusing positions. For example, M4A and M4D become larger, and M4B and M4C become smaller. Therefore, FE signals can be obtained by calculating differences of F1 and F2 from the following formula (6):

FE=F1−F2 (6)

wherein F1 and F2 respectively denote a sum of outputs of each strip region in which the sum is obtained by connecting the divided regions as shown in FIG. 8.

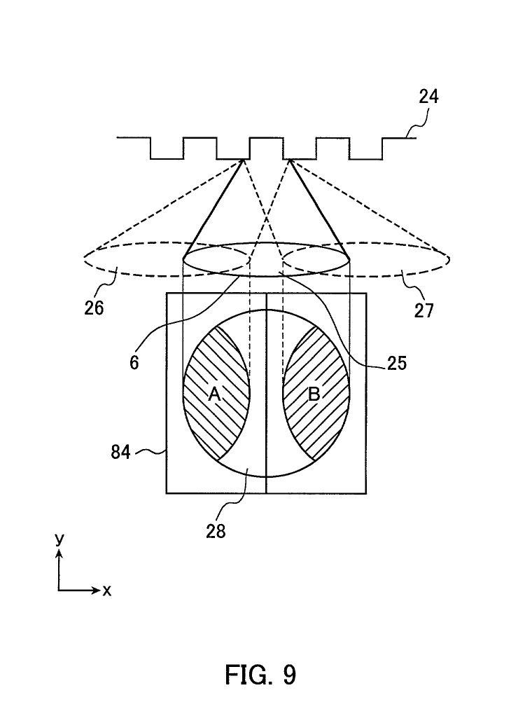

The projection direction of the direction in which a track of the DVD optical disk 71 extends (tangential direction) is adjusted in the y-direction, and the radiation direction extending from the center of the disk to the outer peripheral portion (radial direction) is adjusted in the x-direction. A recordable optical disk such as DVD-RAM and the like has guide grooves, and the disk is affected strongly by the diffraction of the guide grooves as shown in FIG. 9. In FIG. 9, reference numerals 25, 26, and 27 denote a zero-order, +first-order, and −first order diffracted light due to the guide grooves on the optical disk recording surface, respectively. Furthermore, reference numeral 84 denotes a two-divided photodetector that is used for explanation. The photodetector 84 shows a state seen from the direction of the optical axis that is a direction perpendicular to the optical disk surface 24 and the objective lens 6. That is, the upper half of FIG. 9 is drawn by an elevation view, and the lower half of the FIG. 9 is drawn by a plan view.

When the guide groove of the recording surface 24 of the optical disk is irradiated with a converging spot, the reflected light is diffracted in the direction perpendicular to the direction in which the guide groove extends. In a far-field pattern (FFP) 28 returning to the objective lens surface, due to the interference of the ±first order diffracted light and zero order diffracted light in the guide groove, the variation of light intensity occurs in A or B as in the FFP 28. Depending upon the positional relationship of the guide groove and the converging spot, a portion A may become bright and a portion B may become dark, and, on the contrary, the portion A may become dark and the portion B may become bright.

By detecting such a change in the optical intensity by the use of a 2-divided photodetector, TE signals can be obtained by the PP method. In the embodiment shown by FIG. 8, since the hologram 4 (FIG. 8 shows only a red light 4R on the hologram) is positioned in the two-divided photodetector 84 in FIG. 9, when the divided regions of the hologram 4 and the divided regions of the photo detecting portion where the diffracted lights reach from each divided region are taken into account, the tracking error (TE) signals can obtained by the push-pull method by calculating from the following equation (7).

TE=(TA+TB)−(TC+TD) (7)

wherein signal strength is expressed by the name of the region (the same is true in the following).

Furthermore, when reproducing information from DVD-ROM, it is necessary to use TE signals by the phase difference method. In such a case, however, by comparing the phase of the signal (TA+TC) with the signal (TB+TD), TE signals can be obtained by the phase difference method. Also, it is possible to obtain TE signals by the phase difference method by comparing the phase of TA and TB with the phase of TC and TD.

Furthermore, among the diffracted lights for detecting the FE signal received at the photo detecting portion 82, for example, M4A and M4D are focused on the opposite side of the collimating lens 5 (FIG. 1) with respect to the surface of the photo detecting portion 82 (this will be referred to as a rear pin); and M4B and M4C are focused on the same side as the collimating lens 5 (FIG. 1) with respect to the surface of the photo detecting portion 82 (this will be referred to as a front pin). In other words, the diffracted light diffracted from the region 4A of the hologram 4 and the diffracted light diffracted from the region 4D of the hologram 4 have the same property. When equalizing the property of the hologram 4 for the light diffracted from the region symmetrical to the y-axis corresponding to the tangential direction of the optical disk 7, when FE signals are detected, in the change in the amount of lights in the portions A and B described with reference to FIG. 9, offset each other. For example, when the amount of the light in the portion A is increased due to the deviation of track, the amount of the light in the portion B is reduced by the increased amount of the light in the portion A. When the change the amount of the light in the portion A and the change of the amount of the light in the portion B are added, the sum becomes zero. Therefore, even if the TE signals are changed, the FE signals are not affected by the change, and it is possible to prevent the contamination of TE signal into FE signals, i.e., the occurrence of the groove traverse signal because of the diffracted light diffracted from the regions.

Next, the information (RF) signals can be obtained from the following equation (8):

RF=TA+TB+TC+TD (8)

Furthermore, the RF signals can be obtained from the following equation (9) by using all the ±first-order diffracted lights, and it is possible to improve the ratio of signal/noise (S/N) with respect to the electrical noise.

RF=TA+TB+TC+TD+F1+F2 (9)

As is apparent from the equations (4) and (5) and FIG. 8, when the distance between the center of the photo detecting portion 82 and the center of the photo detecting portion 83 is made to be twice the distance d12, it is possible to match the center of the photo detecting portion with the center of the diffracted light, thus enabling the light to be received without leakage although an error occurs due to the change in the wavelength.

Furthermore, by forming the region 82 of the five strip-shaped divided regions, it is possible to separate the diffracted light M4D from the diffracted light M4A appropriately. Furthermore, it is possible to separate the diffracted light M4D from the diffracted light M4A appropriately. Accordingly, the conjugated lights thereof can be separated, that is, the diffracted light P4D can be separated from P4A appropriately. Similarly, the diffracted light P4B can be separated from P4C appropriately. Therefore, in the photo detecting portion 81, signals of the four diffracted lights can be detected separately and thus TE signals can be obtained by the phase difference method more excellently.

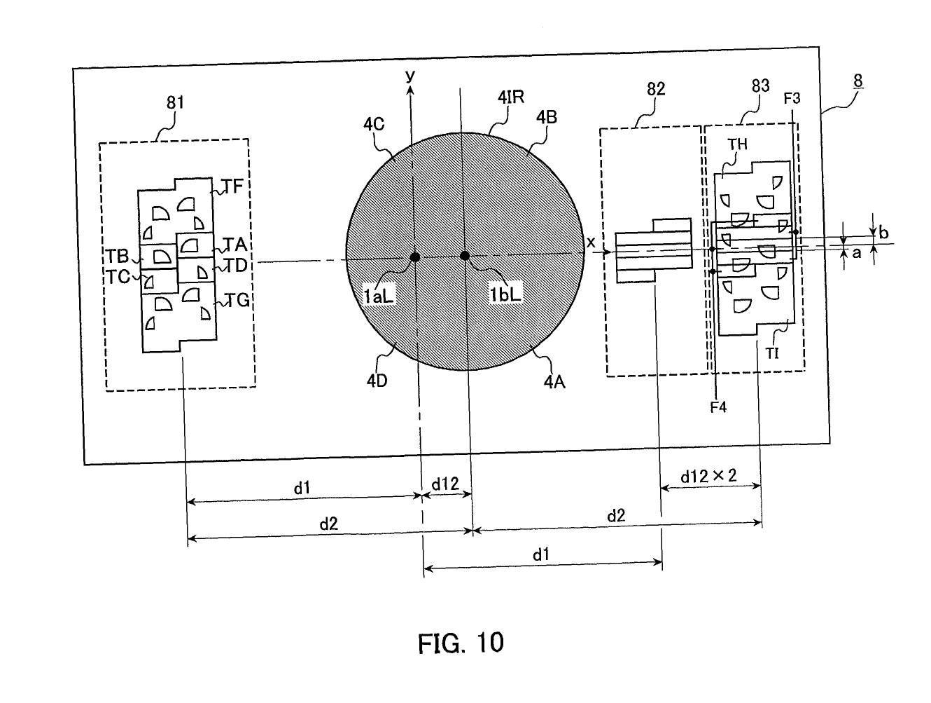

FIG. 10 shows an operation of recording or reproducing information from a CD optical disk by allowing an infrared light to be emitted in the same configuration as in FIG. 8. When the gap between the CD optical disk 72 and the objection lens in the direction of the optical as is shifted, that is, when defocusing occurs, the magnitude of the diffracted light on the photo detecting portion 82 changes. The change is a reverse movement with respect to the difference of the focus position. Therefore, FE signals can be obtained by calculating differences of F3 and F4 from the following formula (10):

FE=F3−F4 (10)

wherein F3 and F4 respectively denote a sum of outputs of each strip region in which the sum is obtained by connecting the divided regions of the photo detecting portion 83 as shown in FIG. 10. At this time, since the hologram 4 is divided into four regions by the x-axis and y-axis, the magnitudes of the four diffracted lights for detecting signals of F3 and F4 are not the same as each other, which does not affect the detection of FE signal. Furthermore, by connecting, for example, F1 and F3, F2 and F4 in the photodetector, it is possible to reduce the number of I-V amplifiers for converting a current signal obtained from the photo detecting portion into a voltage signal, or the number of the electric terminals for taking out signals from the unit to the outside, thus enabling the unit to be miniaturized.

The thickness of the base material of DVD is different from that of CD. Therefore, if FE signals are detected on the same shaped photo detecting portions, the offset may occur in the FE signals due to the spherical aberration. Thus, as shown in FIG. 10, by modifying such as shifting the symmetric line (central line) along the x-axis of the photo detecting portion 83 with respect to the symmetric line along the x-axis of the photo detecting portion 82, this FE offset can be reduced.

FIG. 10 shows a state in which two longer dividing lines in the middle of the string region of the photo detecting portion 83 are not located at the same distance with respect to the symmetrical line of the photo detecting portion 82 (a is not equal to b). Furthermore, since the magnitude of the diffracted light also becomes different due to the effect of the wavelength spherical aberration, by changing the widths of the strips between the photo detecting portion 82 and the photo detecting portion 83, it is possible to obtain an FE signal having a high sensitivity and a broad dynamic range.

When reproducing information from CD, TE signals can be detected by the phase difference method similarly to the time of information reproduction from DVD. However, in CD-R, the 3-beam method is secured in the standardization and as shown in FIG. 3, the diffraction grating 3 is provided. Although not shown in the figure, a part of the red infrared light is diffracted by the diffraction grating 3 to form a sub-beam. This sub-beam, similar to the main beam, is converged onto the CD optical disk 72, reflected thereby and enters a divided regions TF, TG, TH, and TI on the photodetector 8. TE signals by the 3-beam method can be detected by calculating from the following equation (11).

TE=(TF+TH)−(TG+TI) (11)

In the photodetector 8, by interconnecting TF and TH by the use of an aluminum wiring, it is possible to reduce the number of the output terminals to the outside, thus miniaturizing the unit. The same is true in TG and TI.

Furthermore, TE signals can be detected by the 3-beam method by the use of the following equation (12) or (13):

TE−TF−TG (12)

TE=TH−TI (13)

In this case, it is possible to reduce the number of the output terminals to the outside and to miniaturize the unit.

Next, information (RF) signals can be obtained from the following equation (14):

RF=TA+TB+TC+TD (14)

The information (RF) signals can be obtained from the following equation (15) by using all the ±first-order diffracted lights, and thereby it is possible to improve the ratio of signal/noise (S/N) with respect to the electrical noise.

RF=TA+TB+TC+TD+F3+F4 (15)

Moreover, in the above mentioned, F1, F2, F3, and F4 are described in a way in which they are independent from each other. However, for example, by interconnecting F1 and F3, and F2 and F4, it is possible to reduce the number of the output terminals to the outside and to miniaturize the unit.

(Fifth Embodiment)

In the first embodiment, the outline of the diffraction grating 3 was explained. The diffraction grating 3 will be explained in more detail with reference to FIG. 11. FIG. 11 is a cross-sectional view showing a diffraction grating body including the diffraction grating 3. On a base material 142, a diffraction grating 3 for generating three beams is formed. Furthermore, on the base material 142, a base material 141 on which a hologram is formed is bonded.

As mentioned above, if the depth h of the grating (see FIG. 4) satisfies the equation (1), the diffraction of the red light does not occur in theory. If the refractive index n1 of the base material 142 forming the diffraction grating 3 is about 1.5, when n1=1.5 and the wavelength of red light λ1=650 nm are substituted into the above-mentioned equation (1),

h=650 nm/(1.5−1)=650 nm×2

is obtained.

In other words, the depth h of grating is twice the wavelength λ1. In an assumption based on the scalar calculation: with the diffraction grating having a shallow depth h of grating, the transmitting efficiency of the red light becomes 100%. However, when the depth h of grating becomes as large as about h=1.3 μm (650 nm×2), the grating depth is not included in a thin diffraction grating according to the assumption of the scalar calculation. In this case, if the vector calculation is carried out precisely, the transmitting efficiency becomes about 80%, thus generating about 20% loss of light.

Glass or plastic widely used as an optical material is advantageous in that it is cheap and has excellent processability, and further easily available. However, the transmissivities of such materials are at most about 1.7. Therefore, as mentioned above, the depth h of grating is required to be large, thus resulting in the increase of the loss of light amount.

In this embodiment, for a material of the base material 142 forming the diffraction grating 3, instead of glass or plastic, a material with high refractive index is used. An example of the material with high refractive index includes, for example, a Ta₂O₅ (tantalum oxide) film. The refractive index of the Ta₂O₅ film with respect to the red light is 1.9 or more and about 2.1 or less, although it depends on the formation conditions. When n1=2 and the wavelength of red light λ1=650 nm are substituted into the above-mentioned equation (1),

h=650 nm/(2−1)=650 nm

is obtained. The depth h of grating becomes half as compared with the case of the refractive index of n1=1.5.

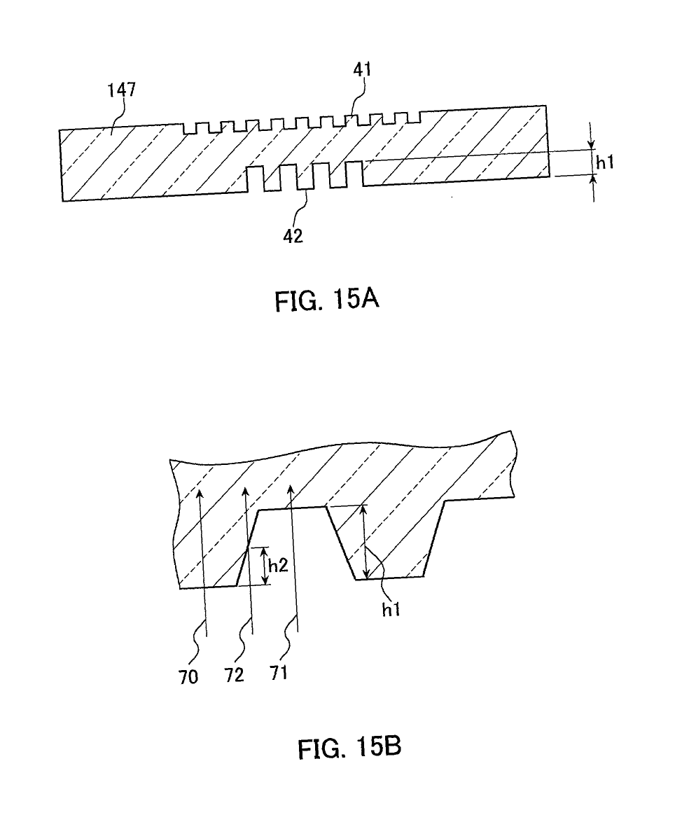

Thus, in the case where the depth h of the grating is about 0.65 μm (650 nm), the calculated transmissivity of the red light with respect to the grating with a periodic cycle of 6 μm, it is about 95% or more, and thus the loss of light amount becomes about 5%. Therefore, in this embodiment, as compared with the configuration in which the material with refractive index of about 1.5 and the loss of light amount is about 20%, the loss of the light amount can be reduced to about ¼. Furthermore, if the depth h of the grating is as small as about 0.65 μm, the cross-sectional shape of the diffraction grating can be formed easily in an ideal rectangular shape. Consequently, it is possible to reduce the generation of the phase difference due to the inclination of the sidewall as explained with reference to FIG. 15B.

In the above-mentioned example, the case where the refractive index n1 is 2 was explained. When the refractive index is 1.9 or more, the similar effect can be obtained. That is, when the diffraction grating is formed of a material with high refractive index of 1.9 or more and has a depth h of grating, which was calculated from the above-mentioned equation (1), it is possible to obtain the diffraction grating for generating three beams, in which the infrared light is diffracted, the red light is not diffracted and the refractive index of the red light is high.

In the above, as the material with high refractive index, the case of using Ta₂O₅ was explained. However, it is to be noted that the material is not limited to Ta₂O₅ and other materials also can be used. For example, TiO₂ (refractive index: about 2.3), ZrO₂ (refractive index: about 1.95), Nb₂O₃ (refractive index: about 2.3), ZnS (refractive index: about 2.3), LiNbO₃ (refractive index: about 2.0), LiTaO₃ (refractive index: about 1.9 to 2.0), and the like may be used.

In the diffraction grating body shown in FIG. 11, the base material 142 on which the diffraction grating 3 is formed and the base material 141 on which the hologram 4 is formed are prepared separately and both are bonded to each other. With this configuration, the base material 142 can be formed of a thin film of a material with high refractive index and for the base material 142 as a parent material, a cheap glass or resin can be used. Therefore, it is not easy to form a large volume of uniform materials and is possible to minimize the amount of use of an expensive material with high refractive index. Furthermore, in the diffraction grating in this case, since the rate of the base material 141 with a low refractive index is increased, it is possible to obtain another effect in that the height of the diffractive grating body can be lowered.

In the case where a thin film of the material with high refractive index is formed by vapor deposition, the temperature of the base material 141 to be vapor-deposited also becomes high. Therefore, for the base material 141, it is preferable to use glass whose thermal resistance is higher than that of resin.

Furthermore, instead of the configuration as shown in FIG. 11 in which the base material 141 and the base material 142 are formed separately, the base material 141, which is a parent material, itself may be made to be a material with high refractive index and the diffraction grating 3 may be formed on the base material 141 itself without using the separate bonded body. In the configuration in which the diffraction grating body is formed of only a single body, it is disadvantageous from the viewpoint of cost, but manufacturing becomes easy because the members are not bonded to each other. Also with this configuration, it is possible to obtain a 3-beam generating diffraction grating 3 with high refractive index with respect to the red light in which the infrared light is diffracted and the red light is not diffracted.

Furthermore, by providing a semiconductor laser apparatus (unit) with the 3-beam generating diffraction grating, the laser light sources each having different wavelength (infrared light and red light) and photodetector, it is possible to realize a semiconductor laser apparatus which is capable of reproducing information from CD-R stably and in which the efficiency of using light at the time of reproducing information from DVD is enhanced. Furthermore, also with an optical pick-up apparatus or optical information apparatus using this unit and the objective lens, it is possible to reproduce information from the CD-R stably. Furthermore, at the time of reproduction from DVD, the efficiency in using light can be enhanced. That is, it is possible to realize an apparatus in which the S/N ratio is high, reproduction can be carried out stably and the power consumption is low.

Moreover, in the hologram 4, diffraction occurs also in an outward path from the light sources (1a, 1b) to the optical disk 7. When the diffracted light on the outward path is reflected by the optical disk 7 and enters the photodetectors (81, 82, 83), the light becomes unnecessary stray light, which may lead to an offset of servo error signal or noise of the information reproducing signals.

Then, in order to shield such a stray light, it is desirable to provide an aperture (aperture stop) 17 in the same plane as the hologram 4. The aperture 17 can be provided by forming a diffraction grating or allowing the metal film to be vapor deposited with respect to the base material 141. In the case where the aperture 17 is formed by the use of the metal film, Ni or Cr may be used as a material. However, the light reflected by the metal film may become a factor of direct-current stray light. From this viewpoint, Cr having a high absorptance with respect to the visible light is desirable.

In other words, it is further possible to obtain the effect in that the stray light due to the reflection occurring can be reduced as a result of forming the aperture 17 by Cr film.

Furthermore, also in the case where a diffraction grating body having a convexity and concavity is produced generally, by forming a material having a refractive index of 1.9 or more on a parent material having a refractive index of less than 1.8, such as glass etc., to thus provide the high refractive index material with convexity and concavity, it is possible to obtain the effect in that efficiency of using light can be enhanced cheaply.

(Sixth Embodiment)

Anther embodiment of the diffraction grating 3 will be explained with reference to FIG. 12. FIG. 12 is a cross-sectional view showing a diffraction grating body including the diffraction grating 3. On a base material 142 using a material with having a high refractive index, a 3-beam generating diffraction grating 3 is formed. Furthermore, on the base material 142, a base material 141 on which a hologram is formed is bonded. This embodiment is different from the above-mentioned embodiment in that anti-reflection films 142 and 143 are formed an both surfaces of the base material 142.

In the present invention, since the transmissivity of red light on the 3-beam grating is aimed to be enhanced, it is important to improve the transmissivity by anti-reflection coating. In the configuration in which the anti-reflection film is not formed on the interface between the base material 142 with high refractive index and the air, the refractive index n1 of the base material 142 is n1=2, about 11% of reflection loss is generated. Thus, the anti-reflection film 144 has a great effect.

The anti-reflection film 144 can be formed of SiO₂ thin film. Furthermore, the anti-reflection film (matching coat) 143 in the interface between the base material 142 with high refractive index and the base material 141 can be formed of a thin film of Al₂O₃ or SiN.

In this embodiment, the following manufacturing process is carried out. The anti-reflection film 143 of Al₂O₃ or SiN is formed on the base material 141 such as glass etc. Furthermore, the base material 142 is prepared by using the material mentioned in the fourth embodiment. Then, the diffraction grating 3 is formed by etching or other techniques. Furthermore, the anti-reflection film 144 of SiO₂ or the like is formed.

In order to secure the depth h of the diffraction grating (see FIG. 4), it is necessary to make the thickness of the base material 142 with high refractive index to be h or more. However, when the thickness of the base material 142 with high refractive index is equal to h, it is possible to form a diffraction grating by a lift-off technique.

Although not shown in FIG. 12, in order to enhance the efficiency of using light, it is desirable that the anti-reflection film of MgF₂ etc. is formed also on the surface of the hologram 4.

Similar to the fifth embodiment, this embodiment also can be applied to a semiconductor laser apparatus (unit) having the diffraction grating mentioned in this embodiment, an optical pick-up apparatus and an optical information apparatus. Thus, the same effect as in the embodiment 6 can be obtained.

(Seventh Embodiment)

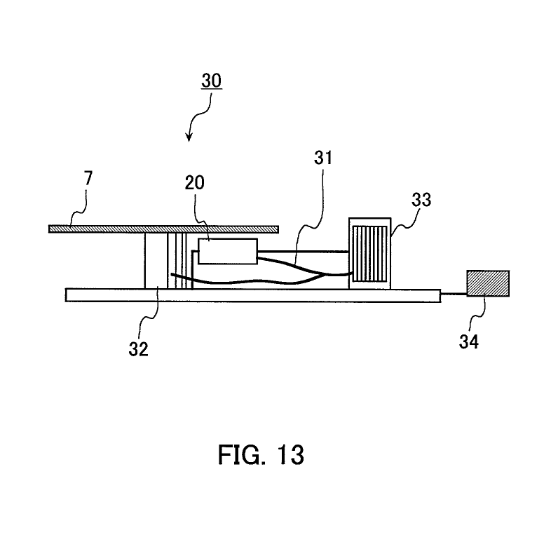

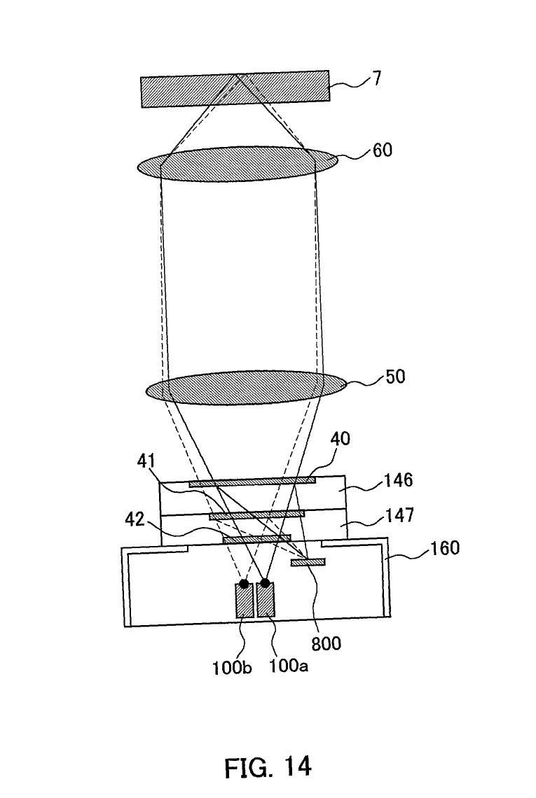

FIG. 13 is a schematic view showing a configuration of an optical information apparatus according to one embodiment of the present invention. An optical pick-up 20 shown in FIG. 13 uses any one of the optical pick-ups according to the above-mentioned embodiments and uses the diffraction grating explained in the fifth embodiment or sixth embodiment.

The optical disk 7 is rotated by the optical disk driving mechanism 32. The optical pick-up 20 is moved finely (seek operation) to the position of the track in which the predetermined information of the optical disk 7 exists, by an optical pick-up driving device 31.

The optical pick-up 20 feeds a focus error signal and a tracking error signal to an electric circuit 33 in accordance with the positional relationship with respect to the optical disk 7. The electric circuit 33 responds to the signals and feeds signals for fluttering the objective lens to the optical pick-up 20. By this signal, the optical pick-up 20 carries out focus servo and tracking servo on the optical disk 7, and reads out, writes or erases information with respect to the optical disk 7.

According to the optical disk apparatus of this embodiment, as the optical pick-up, a small size optical pick-up capable of obtaining an excellent S/N ratio at low cost is used, and it is possible to reproduce information accurately and stably. Furthermore, an effect of having a small size and low cost can be provided.

Furthermore, since the optical pick-up of the present invention uses the diffraction grating body according to the present invention, the efficiency of using the light is enhanced, the access time becomes shorter and power consumption is reduced.

As mentioned above, according to the present invention, the base material for forming the diffraction grating is formed of a high refractive index material, thereby enabling the depth of grating of the diffraction grating to be shallow. Consequently, it is possible to prevent the loss of the amount of light that is not diffracted. In the configuration in which base materials having different refractive indexes are bonded to each other, it is possible to minimize the amount of use of relatively expensive material with a high refractive index. Furthermore, in the configuration in which the diffraction grating is formed of a single base material, manufacturing becomes easy although it is disadvantageous from the viewpoint of cost.

The embodiments mentioned above are to be intended to clarify the art of the invention and are not limited to the above-mentioned embodiments alone. The present invention should be considered broadly and all changes which come within the spirit of the invention and within the meaning and range of equivalency of the claims are intended to be embraced therein.

What is claimed is:

1. A transmission diffraction grating body comprising:
a base material being substantially transparent with respect to wavelength λ1 and having a refractive index n0;
another base material being substantially transparent with respect to wavelength λ1 and having a refractive index n1, which is formed on the base material having a refractive index n0; and
a relief diffraction grating formed on the base material having a refractive index n1; wherein:
the refractive indexes n1 and n0 satisfy the following relationship:
n1>n0.

2. The diffraction grating body according to claim 1, wherein the diffraction grating is formed of a concave portion and a convex portion having rectangular-shaped cross sections, and the level difference h between the concave portion and the convex portion satisfies the following relationship:
hλ1/(n1−1)
and the difference in an optical path between the concave portion and the convex portion is set to correspond to one wavelength with respect to the wavelength λ1.

3. The diffraction grating body according to claim 1, wherein the refractive index n1 is 1.9 or more.

4. The diffraction grating body according to claim 1, wherein a material of the base material having the refractive index n1 is at least one material selected from the group consisting of Ta₂O₅, TiO₂, ZrO₂, Nb₂O₃, ZnS, LiNbO₃ and LiTaO₃.

5. The diffraction grating body according to claim 1, wherein the diffraction grating is formed of a concave portion and a convex portion having rectangular-shaped cross sections, and the film thickness of the base material having the refractive index n1 is the same as the level difference h between the concave portion and the convex portion.

6. The diffraction grating body according to claim 1, further comprising an anti-reflection film in the interface between the base material having a refractive index n1 and the air, and the interface between the base material having the refractive index n1 and the base material having a refractive index n0.

7. A transmission diffraction grating body, comprising a base material, and a relief diffraction grating formed on the base material, wherein the diffraction grating body is formed of a single base material; and the refractive index n1 of the single base material is 1.9 or more.

8. The diffraction grating body according to claim 7, wherein the diffraction grating is formed of a concave portion and a convex portion having rectangular-shaped cross sections, and the level difference h between the concave portion and the convex portion satisfies the following relationship:
hλ1/(n1−1)
and the difference in an optical path between the concave portion and the convex portion is set to correspond to one wavelength with respect to the wavelength λ1.

9. The diffraction grating body according to claim 7, wherein a material of the single base material is at least one material selected from the group consisting of Ta₂O₅, TiO₂, ZrO₂, Nb₂O₃, ZnS, LiNbO₃ and LiTaO₃.

10. A semiconductor laser apparatus provided with a diffraction grating body according to any one of claims 1 to 9, comprising:
a semiconductor laser for emitting a light beam with wavelength λ1 and a light beam with wavelength λ2; and
a photodetector for receiving the light beams emitted from the semiconductor laser and carrying out photoelectric conversion; wherein:
the diffraction grating body receives the light beam with wavelength λ2 and transmits a main beam and generates sub-beams that are ±first order diffracted light; and
the diffraction grating body, the semiconductor laser and the photodetector are integrated into one package.

11. An optical pick-up provided with a diffraction grating body according to any one of claims 1 to 9, comprising:
a first semiconductor laser light source for emitting a light beam with wavelength λ1;
a second semiconductor laser light source for emitting a light beam with wavelength λ1;
an optical system for receiving the light beam with wavelength λ1 and the light beam with wavelength λ2 and converging the light beam onto a microspot on the optical disk;
a diffraction means for diffracting a light beam reflected from the optical disk; and
a photodetector having a photo detecting portion for receiving the diffracted light diffracted by the diffraction means to output electrical signals in accordance with the amount of the diffracted light; wherein
the diffraction grating body receives the light beam with wavelength λ2 and transmits a main beam and generates sub-beams that are ±first order diffracted light.

12. The optical pick-up according to claim 11, wherein the photo detecting portion comprises a photo detecting portion PD0 for receiving a +first order diffracted light from the diffraction means, and a distance d1 between the center of the photo detecting portion PD0 and the light emitting spot of the first semiconductor laser light source and a distance d2 between the center of the photo detecting portion PD0 and the light emitting spot of the second semiconductor laser light source substantially satisfy the following relationship:
λ1/λ2=d1/d2.

13. The optical pick-up according to claim 11, wherein the diffraction grating body, the semiconductor laser and the photodetector are integrated into one package.

14. An optical information apparatus provided with the optical pick-up according to claim 11, comprising:
a focus control means with respect to an optical disk;
a tracking control means; and
an information signal detecting means; and further comprising:
a moving means for moving the optical pick-up; and
a rotation means for rotating the optical disk.
